(19) United States
(12) Patent Application Publication
(10) Pub. No.: US 2008/0159644 A1
(43) Pub. Date: Jul. 3, 2008

(54) CONDITION DEPENDENT SHARPENING IN AN IMAGING DEVICE

(76) Inventors: Sean C. Kelly, Rochester, NY (US); Scott C. Cahall, Fairport, NY (US)

Correspondence Address: Frank Pincelli;Patent Legal Staff, Eastman Kodak Company, 343 State Street, Rochester, NY, 14650-2201, US

(21) Appl. No.: 11/616,944

(22) Filed: Dec. 28, 2006

(51) Int. Cl. G06K 9/40

(52) U.S. Cl. 382/261

(57) ABSTRACT

Blur is reduced in an image generated by an imaging device by determining values of one or more atmospheric variables for the image, the one or more atmospheric variables characterizing conditions under which the image is generated. With these values, a sharpening filter is determined for the image. The sharpening filter is derived from a modulation transfer function of the imaging device at conditions characterized by the values of the one or more atmospheric variables determined for the image. The sharpening filter is subsequently applied to the image.

### FIELD OF THE INVENTION

The present invention relates generally to digital imaging devices, and, more particularly, to reducing atmospheric-condition-induced defocus blur in images.

### BACKGROUND OF THE INVENTION

Temperature and humidity fluctuations acting on optical components in an imaging device may cause the optical characteristics of the optical components to vary, thereby adversely affecting the performance of the imaging device. Temperature and humidity changes may, for example, cause optical components to change index of refraction, change shape and move within their mounts. Such manifestations are especially prevalent in imaging devices including plastic optical components. Plastic optical components such as those found in inexpensive cameras frequently have an index of refraction that changes to a greater degree in response to atmospheric conditions than that of glass optical components. As a result, plastic optical components may not be able to hold focus in as large a temperature and humidity range as glass optical components.

Attempts have been made to correct atmospheric-condition-induced defocus blur in various imaging devices. Changes in focus resulting from atmospheric conditions may be compensated for to some extent through, for example, appropriate optomechanical designs. Optomechanical designs are described in several readily available references such as A. Ahmad (editor), Handbook of Optomechanical Engineering, CRC, 1996. In such designs, materials and mounting schemes are selected that respond to atmospheric conditions in such a way as to offset any focus change associated with changes in the atmospheric conditions. Usually this requires choosing materials that have small thermal expansion coefficients. Unfortunately, due to these choice constraints, solutions are often physically large and do not lend themselves to size-constrained systems such as small cameras. Moreover, because of high costs, optomechanical solutions may not be feasible in inexpensive imaging devices.

As a result, there is a need for methods and apparatus operative to reduce blur in images captured with imaging devices manifesting atmospheric-condition-induced defocus.

### SUMMARY OF THE INVENTION

Embodiments of the present invention address the above-identified need by providing methods and apparatus for reducing blur in images captured with imaging devices manifesting atmospheric-condition-induced defocus.

In accordance with an aspect of the invention, blur is reduced in an image generated by an imaging device by determining values of one or more atmospheric variables for the image, the one or more atmospheric variables characterizing conditions under which the image is generated. With these values, a sharpening filter is determined for the image. The sharpening filter is derived from a modulation transfer function (MTF) of the imaging device at conditions characterized by the values of the one or more atmospheric variables determined for the image. The sharpening filter is subsequently applied to the image.

In accordance with one of the above-noted embodiments of the invention, a digital camera suffers from atmospheric-condition-induced defocus blur. The digital camera comprises temperature and humidity sensors, a filter memory and an image processor. The manufacturer of the digital camera loads the filter memory with several sharpening filters for different temperature and humidity conditions. These sharpening filters are derived from MTF measurements performed by the manufacturer over a range of temperature and humidity conditions. When a user takes an image, temperature and humidity are measured for that image by the temperature and humidity sensors in the digital camera. The sharpening filter corresponding to these temperature and humidity measurements is retrieved from the filter memory. The image processor applies this sharpening filter to the image, thereby reducing blur in the image.

These and other features and advantages of the present invention will become apparent from the following detailed description which is to be read in conjunction with the accompanying drawings.

### BRIEF DESCRIPTION OF THE DRAWINGS

FIG. 1 shows a block diagram of an illustrative digital imaging system in which aspects of the invention may be implemented;

FIG. 2 shows a block diagram of a digital camera in accordance with aspects of the invention;

FIG. 3 shows a flow diagram of an illustrative process for image sharpening in the FIG. 2 digital camera;

FIG. 4A shows a nominal MTF curve for the FIG. 2 digital camera;

FIG. 4B shows a camera MTF curve for the FIG. 2 digital camera at a particular temperature and humidity condition;

FIG. 4C shows the filter MTF curve for the FIG. 2 digital camera for the particular temperature and humidity condition in FIG. 4B; and

FIG. 5 shows a convolution kernel corresponding to the FIG. 4C filter MTF curve.

### DETAILED DESCRIPTION OF THE INVENTION

The present invention will be described with reference to illustrative embodiments. It is anticipated that numerous modifications can be made to these embodiments and the results will still come within the scope of the invention. No limitations with respect to the specific embodiments described herein are intended or should be inferred.

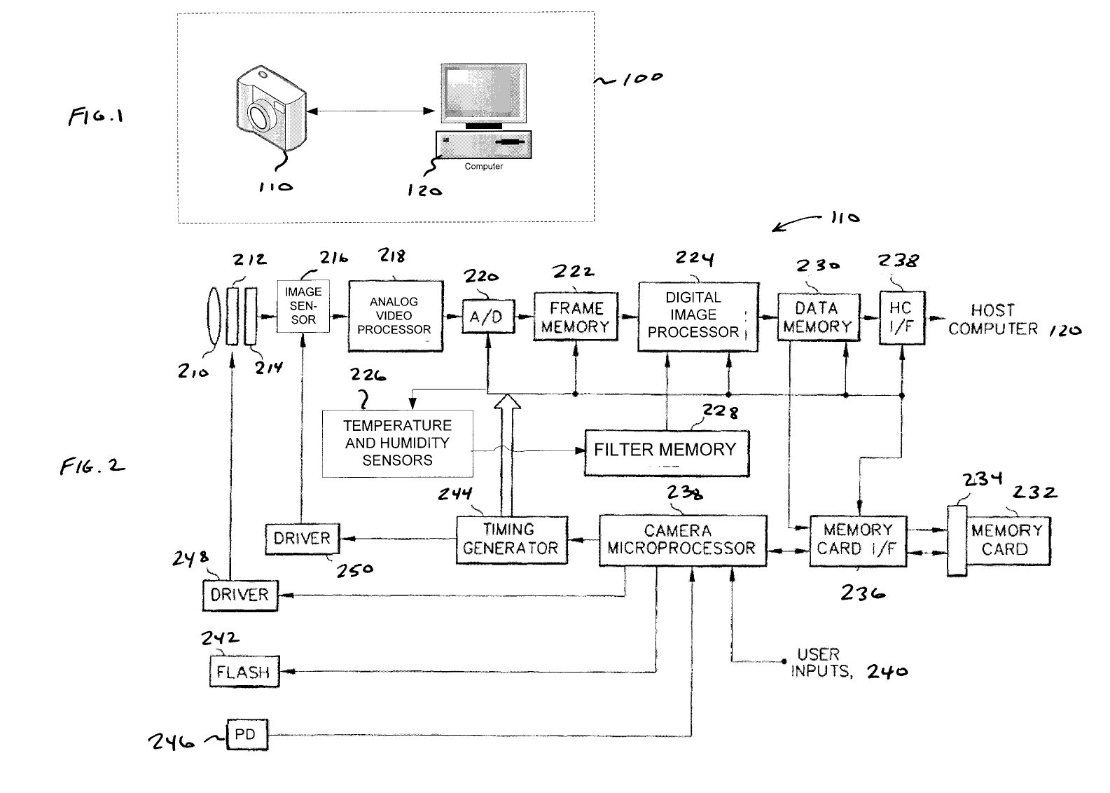

FIG. 1 shows a block diagram of an illustrative digital imaging system 100 in which aspects of the present invention may be implemented. This particular digital imaging system includes a digital camera 110 and a computer 120. Nevertheless, several other configurations are contemplated and would come within the scope of the invention. Rather than the digital camera, the imaging system could, for example, include a film camera with an optical scanner operative to convert images developed on film into digital data. Alternatively, the imaging system could include a video camera instead of still camera. The digital camera may be combined with another device such as a mobile telephone, personal digital assistant (PDA) or wireless electronic mail device.

FIG. 2 shows further details of the digital camera 110. A lens 210 directs image light from a subject (not shown) through an aperture/shutter controller 212 and an anti-aliasing filter 214 upon an image sensor 216, which is preferably a charge coupled device (CCD) sensor or a complementary metal-oxide-semiconductor (CMOS) imager. The image sensor generates an image signal that is processed by an analog video processor 218 before being converted into an image signal by an analog-to-digital (A/D) converter 220. The digitized image signal is temporarily stored in a frame memory 222, and then processed and compressed by an image processor 224. Temperature and humidity sensors 226 and a filter memory 228 are coupled to the image processor in order to facilitate temperature- and humidity-dependent image processing, described in greater detail below. Once processed and compressed, the compressed image signal is then stored in a data memory 230 or, if a memory card 232 is present in a memory card slot 234, transferred through a memory card interface 236 to the memory card.

A camera microprocessor 238 receives user inputs 240, such as from a shutter release switch, and initiates a capture sequence by triggering a flash unit 242 (if needed) and signaling a timing generator 244. The timing generator is connected generally to the elements of the digital camera, as shown in FIG. 2, for controlling temperature/humidity measurements, digital conversion, compression, and storage of the image signal. The microprocessor also processes a signal from a photodiode (PD) 246 for determining a proper exposure, and accordingly signals an exposure driver 248 for setting the aperture and shutter speed. The image sensor 216 is driven from the timing generator via a sensor driver 250 to produce the image signal.

Once stored in the camera data memory 230 or memory card 232, the compressed images may be sent to the computer 120 via a host computer interface 238 or, alternatively, by removing the memory card from the digital camera and having the computer read the data from the memory card directly using a memory card reader. The computer will preferably include software operative to store, transmit, print and further modify the images. The computer may be a general purpose computer such as, for example, a personal computer from what is commonly referred to as the “IBM PC Compatible” class of computers. Alternatively, the computer may be a purpose-specific computing device.

For purposes of illustrating aspects of the invention, it will be assumed that the optical components of the digital camera 110 suffer from atmospheric-condition-induced defocus blur. More specifically, it will be assumed that changes in two atmospheric variables, namely, temperature and humidity, cause the optical components of the digital camera to change focus. It is to be appreciated however, that defocus blur attributed to other atmospheric conditions may be reduced using similar techniques.

FIG. 3 shows a flow diagram of an illustrative process for correcting this defocus blur using the components of the digital camera 110 described above. Step 310 in the illustrative process includes provisioning the filter memory 228 with image sharpening filters. This provisioning, in turn, includes several sub-steps which are preferably performed by the camera manufacturer. In a first sub-step, MTFs of the digital camera are determined across the range of temperature and humidity conditions in which the digital camera is desired to operate using a controlled test environment.

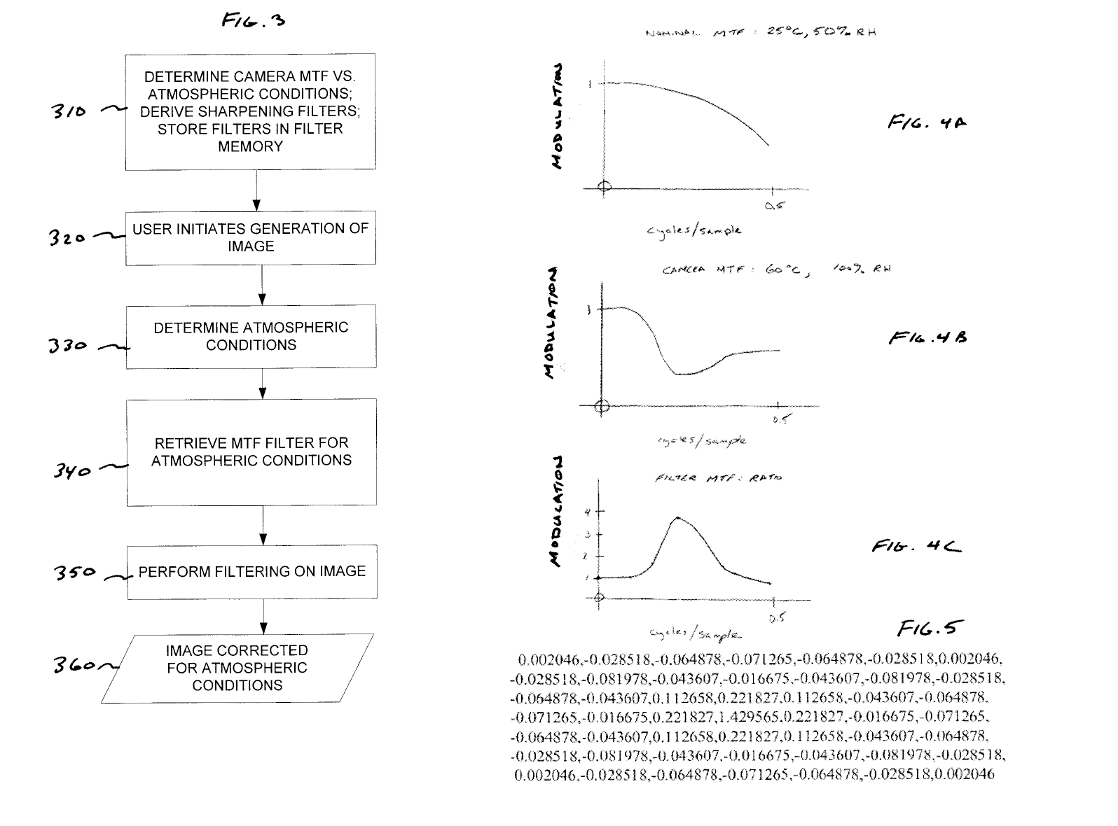

An MTF may be represented as a graph that shows image contrast relative to object contrast (modulation) on the vertical axis over a range of spatial frequencies (cycles/sample) on the horizontal axis. The curve in FIG. 4A, for example, shows an MTF for the digital camera 110 for a particular temperature and humidity condition (i.e., 25° C., 50% relative humidity (RH)). High spatial frequency on the horizontal axis corresponds to small detail in an object. If it were possible to produce a facsimile image of an object, the contrast of the image would be the same as the contrast of the object at all frequencies and the MTF would be described by a straight horizontal line at a modulation level of 1.0. In FIG. 4A, however, modulation at the particular temperature and humidity condition shown falls off as spatial frequency increases.

Several conventional techniques may be utilized to characterize MTFs for the digital camera 110 at the different temperature and humidity conditions, and these techniques will be familiar to one skilled in the art. The digital camera may, for example, be used to image a test chart that is configured in accordance with International Standards Organization (ISO) 12233. This type of test chart includes a multitude of different line patterns with different spatial frequencies and a slant edge feature that allow an MTF to be readily calculated. As another example, an MTF may be determined for the digital camera by imaging a narrow line of light, typically formed by illuminating a slit. Combinations of these and other techniques may also be used.

Once MTFs for the digital camera 110 are determined across the range of anticipated temperature and humidity conditions, sharpening filters may be determined for these same atmospheric conditions. The term “sharpening filter” is to be construed broadly and is intended to encompass a set of filter data rather than a tangible optical device. A sharpening filter is preferably designed with an MTF (“filter MTF”) that is simply the ratio on a point-by-point basis between the MTF of the digital camera at a particular temperature and humidity condition (“camera MTF”) and the MTF of the digital camera at what is considered by the manufacturer to be a nominal temperature and humidity condition (“nominal MTF”). If, for example, the nominal MTF is as shown in FIG. 4A and the camera MTF is as shown in FIG. 4B, then the filter MTF would appear as shown in FIG. 4C. Accordingly, application of a sharpening filter to an image produced with a particular camera MTF will sharpen the MTF of that image so that the image achieves an MTF curve that is similar to the nominal MTF curve for the digital camera. In other words, in the particular example shown in FIGS. 4A-4C, the sharpening filter will act to compensate somewhat for the lower camera MTF at the middle spatial frequencies.

In this way, sharpening filters may be determined as a function of temperature and humidity for the digital camera 110. Once derived, these sharpening filters are preferably stored in the filter memory 228 of the digital camera. They may be stored, for example, as individual sharpening filters for each temperature and humidity condition, or may be represented by one or more mathematical relations that describe the desired sharpening filter as a function of humidity and temperature. Physically, the filter memory may, for example, include a conventional programmable read-only memory (PROM), erasable programmable read-only memory (EPROM) or electrically erasable programmable read-only memory (EEPROM). It may be a portion of a larger camera memory that is also used for another purpose.

Returning again to FIG. 3, step 320 includes the user initiating the generation of an image with the digital camera 110. As the image is generated, the timing generator 244 signals the temperature and humidity sensors 226 to determine the atmospheric conditions present for that particular image in step 330.

Digital temperature sensors (e.g., digital thermometers) and digital humidity sensors (e.g., digital hygrometers) are used in a wide range of electronic applications and, as a result, will be familiar to one skilled in the art. A digital thermometer may, for example, include a thermistor, a thermocouple or a resistance temperature detector. In contrast, a digital hygrometer may include a hygroscopic polymer film that acts to vary a capacitance or resistance in the sensor.

Once temperature and humidity for the image are determined, this information is sent to the filter memory in step 340 and the proper sharpening filter for that atmospheric condition (e.g., the sharpening filter for a temperature and humidity condition closest to that just measured) is retrieved. The retrieved sharpening filter is then sent to the image processor 224. In step 350, the image processor applies the sharpening filter to the image.

Applying a sharpening filter to an image may be performed either in the frequency domain or in the spatial domain. Performing the filtering in the frequency domain may involve, for example, multiplying the filter MTF by the Fourier transform of the image. Applying the sharpening filter in the spatial domain, in contrast, typically requires that the filter MTF be transformed into a convolution kernel. Such a transformation is conventionally performed and, as a result, will be familiar to one skilled in the art. Moreover, such a transformation is described in a number of readily available references such as A. Oppenheim et al., Digital Signal Processing, Prentice-Hall, 1975, which is incorporated herein by reference. FIG. 5, for instance, shows a 7×7 convolution kernel in comma-delimited format corresponding to the filter MTF shown in FIG. 4C. Applying a sharpening filter to an image in the spatial domain is frequently preferred over applying the filter in the frequency domain because doing so often requires less computational resources. Nonetheless, either method yields similar results and would come within the scope of this invention.

After applying the sharpening filter, the image has been corrected for atmospheric conditions present at the time the image was generated, as indicated as result 360. After compressing the image, the image may be stored in the data memory 230 or in the memory card 232 as described above. The digital camera 110 is then ready to generate another image.

It should again be emphasized that, although illustrative embodiments of the present invention have been described herein with reference to the accompanying figures, the invention is not limited to those precise embodiments. For example, a method or apparatus in accordance with aspects of this invention may correct for defocus blur resulting from atmospheric variables in addition to or other than temperature and humidity, such as pressure (thereby requiring that the digital camera be equipped with a digital barometer). Moreover, while sharpening filters in the above-described imaging system 100 were both stored in the digital camera 110 and applied to images in the digital camera, they may instead be stored in the computer 120 and applied to images in the computer as part of the computer's image modification functions after the images have been transferred from the digital camera. In such a case, the digital camera would preferably encode each image with the atmospheric conditions present when the image was generated (e.g., temperature and humidity). The sharpening filters for the digital camera could be provided to the end user for use by the computer on a computer-readable medium (e.g., magnetic disc, compact disc or digital versatile disc) provided with the digital camera at the time of purchase, or, alternatively, through the Internet after purchase. One skilled in the art will recognize these and various other changes and modifications that may be made without departing from the scope of the appended claims.

### PARTS LIST

100 digital imaging system
110 digital camera
120 computer
210 lens
212 aperture/shutter controller
214 anti-aliasing filter
216 image sensor
218 analog video processor
220 analog-to-digital converter
222 frame memory
224 image processor
226 temperature and humidity sensors
228 filter memory
230 data memory
232 memory card
234 memory card slot
236 memory card interface
238 camera microprocessor
240 user inputs
242 flash unit
244 timing generator
246 photodiode
248 exposure driver
250 sensor driver
310-360 processing steps

What is claimed is:

1. A method of reducing blur in an image generated by an imaging device, the method comprising:
determining values of one or more atmospheric variables for the image, the one or more atmospheric variables characterizing conditions under which the image is generated;
determining a sharpening filter for the image, the sharpening filter derived from a modulation transfer function of the imaging device at conditions characterized by the values of the one or more atmospheric variables determined for the image; and
applying the sharpening filter to the image.

2. The method of claim 1, wherein one of the one or more atmospheric variables comprises temperature.

3. The method of claim 1, wherein one of the one or more atmospheric variables comprises humidity.

4. The method of claim 1, wherein one of the one or more atmospheric variables comprises pressure.

5. The method of claim 1, wherein the sharpening filter for the image comprises a modulation transfer function substantially equal to a point-by-point ratio between the modulation transfer function of the imaging device at conditions characterized by the values of the one or more atmospheric variables determined for the image and the modulation transfer function of the imaging device at conditions characterized by different values of the one or more atmospheric variables.

6. The method of claim 1, wherein the step of determining a sharpening filter for the image comprises retrieving information characterizing a sharpening filter from a memory.

7. The method of claim 1, wherein the step of applying the sharpening filter to the image comprises applying the sharpening filter to the image in a frequency domain.

8. The method of claim 1, wherein the step of applying the sharpening filter to the image comprises applying the sharpening filter to the image in a spatial domain.

9. The method of claim 1, wherein the step of applying the sharpening filter to the image comprises applying a convolution kernel to the image.

10. The method of claim 1, further comprising the step of determining modulation transfer functions of the imaging device for respective conditions characterized by the one or more atmospheric variables.

11. The method of claim 10, wherein the step of determining the modulation transfer functions of the imaging device is performed by a manufacturer of the imaging device.

12. An imaging device for which modulation transfer functions have been determined for respective conditions characterized by one or more atmospheric variables, the imaging device operative to generate an image and comprising:
a sensor, the sensor operative to determine values of the one or more atmospheric variables for the image, the one or more atmospheric variables characterizing conditions under which the image is generated;
a memory storing a filter table, the filter table operative to return a sharpening filter for the image, the sharpening filter derived from the modulation transfer function of the imaging device at conditions characterized by the values of the one or more atmospheric variables determined for the image; and
a processor, the processor operative to apply the sharpening filter to the image.

13. The imaging device of claim 12, wherein the sensor comprises at least one of a digital thermometer, a digital hygrometer and a digital barometer.

14. The imaging device of claim 12, wherein the filter table is implemented in a programmable read-only memory, an erasable programmable read-only memory or an electrically erasable programmable read-only memory.

15. An imaging system, the imaging system operative to generate an image and comprising:
an imaging device, modulation transfer functions having been determined for the imaging device for respective conditions characterized by one or more atmospheric variables, the imaging device comprising a sensor, the sensor operative to determine values of the one or more atmospheric variables for the image, the one or more atmospheric variables characterizing conditions under which the image is generated; and
a computing device, the computing device comprising a memory storing a filter table, the filter table operative to return a sharpening filter for the image, the sharpening filter derived from the modulation transfer function for the imaging device at conditions characterized by the values of the one or more atmospheric variables determined for the image, and a processor, the processor operative to apply the sharpening filter to the image.

16. The imaging system of claim 15, wherein the imaging device comprises a digital camera.

17. The imaging system of claim 16, wherein the digital camera digitally encodes the image with the values of the one or more atmospheric variables determined for the image.

18. A method of configuring an imaging system to provide a capability in the imaging system for reducing blur in an image generated by an imaging device of the imaging system, the method comprising:
determining modulation transfer functions of the imaging device for respective conditions characterized by one or more atmospheric variables;
determining sharpening filters for the imaging device for the respective conditions characterized by the one or more atmospheric variables, the sharpening filters derived from the determined modulation transfer functions; and
storing the sharpening filters in a memory.

19. The method of claim 18, wherein the memory is implemented in the imaging device.

20. The method of claim 18, wherein the memory is implemented in a computing device separate from the imaging device.
